(19) United States
(12) Patent Application Publication
(10) Pub. No.: US 2011/0309068 A1
(43) Pub. Date: Dec. 22, 2011

(54) HEATING ELEMENT FOR A HOT AIR DEVICE

(76) Inventor: Jie-Wei Chen, Alpnach Dorf (CH)

(21) Appl. No.: 12/162,209

(22) PCT Filed: Jan. 23, 2007
(86) PCT No.: PCT/EP2007/000542

§ 371 Date: Nov. 25, 2008

(30) Foreign Application Priority Data
Jan. 30, 2006 (EP) 0600180.7

(51) Int. Cl. H05B 3/06; H05B 3/10

(52) U.S. Cl. 219/548

(57) ABSTRACT

The invention concerns a heating element for a hot air device with a heating resistor located in an airflow that comprises at least one air channel for the airflow, and with a heating conductor for converting electric energy to heat, and with a carrier element of thermally stable material for the heating conductor. Essentially, the heating resistor is made entirely of ceramic material. The carrier element has an electrically insulating ceramic material, and the heating conductor has an electrically conductive ceramic material. The ceramic materials of the carrier element and of the heating conductor are connected to each other with full surface-to-surface contact.

### TECHNICAL FIELD OF THE INVENTION

The invention concerns a heating element for a hot air device with a heating resistor located in an air flow, comprising at least one heating conductor for converting electric energy to heat, and a carrier element of thermally stable material for the heating conductor, with the characteristics of the preamble of claim 1.

### DESCRIPTION OF RELATED ART

Such heating elements are known from hot air devices that are commercially available as hot air apparatus, modules, or systems in a wide variety of embodiments, for example as air heaters or hot air welding devices. The body of such a heating element located in a flow of air or gas is commonly made of ceramics or some other heat-resistant material and is located in a heating tube into which air or gas, for example, is blown from one end. The heating element is held by a central pin, for example, on a holder located at the air inlet side. The heating resistor held by a carrier element of the body is also electrically connected via this holder. At the air outlet side of the heating element, there is usually an additional ceramic protection disk that essentially contains air channels. The protection disk is movable and separated from the carrier element, and also sits on a pin-type holder. As heating conductors for the heating resistor it is common to use spiral-shaped heating wires that are fixed in the carrier element at a distance and insulated from each other. The heating wires may be located in air channels of the carrier element that extend from the air inlet to the air outlet side, or on the outer jacket of the carrier element. When an electric voltage is applied, they heat the air and the carrier element.

A device of this type is known from DE 198 39 044 A1 where the heating wires are arranged in a spiral shape in air channels in a carrier element. Such heating elements are costly to manufacture, resulting in high costs per unit. Also, improper handling, for example, may cause a reduction of the airflow by restricting the air inlet or the air outlet which, in turn, usually leads to the destruction of the heating element due to the heating wire burning through. For this reason, commercially available hot air devices are equipped with additional sensors in order to prevent undesirable overheating.

From GB 1 564 630 A, an electric heating element with a high load capacity for a hot air device is known that has at least three adjoining layers of ceramic material connected in parallel to a voltage. By means of doping with common substance elements, the electrical resistance of one of the layers is lowered in comparison with that of the undoped layers. In this context, ceramic material means the familiar oxide, carbide, nitride, boride, or silicide compounds. The electrical properties of the heating element are determined by the doped layer, with a blocking layer of high-purity ceramic material interposed between this and an undoped layer.

### SUMMARY OF THE INVENTION

This invention therefore addresses the problem of proposing an improved heating element with a higher functional reliability of the heating resistor, in particular a better thermal transfer from the heating conductor to the air, and, as a consequence, a higher efficiency.

According to the invention, this problem is solved by a heating element with the characteristics of claim 1. Additional advantageous implementations are described in the subclaims.

According to the invention, the heating resistor has at least two coaxial heating elements whose tube-shaped carrier elements are located at a distance from each other in the radial direction and delimit air channels that are oriented coaxially to each other. The electrical path and thereby the electrical resistance can be influenced by the number of the tubes that contain the electrical conductors. For example, it is possible to use several tubes with thinner wall thicknesses instead of two tubes with thicker walls. This is a special advantage over heating elements with a conventional structure that, in principle, can also be equipped with a conductive ceramic layer. In between themselves, the tubes form coaxial air channels as passages for the air, and act as carrier element for the heating conductor. As described above, on their inner and outer surfaces, they have a conductive ceramic layer serving as heating conductor. Due to their large cross-sectional areas, the tube-shaped air channels have a favorable flow resistance for the airflow so that the air can flow largely unimpeded through the carrier element. The air flows over the heated inner and outer surfaces of the tubes of the heating resistor, is heated in the process, and carries the heat through the outlet opening of the heating element.

The carrier element of the heating resistor has an electrically insulating ceramic material, and the heating conductor has an electrically conductive ceramic material, with the ceramic materials of the carrier element and of the heating conductor being in full surface-to-surface contact with each other. The heating resistor of the heating element according to the invention is based 100 percent on ceramics. The new structural concept simplifies the entire production process, and in particular shortens the manufacturing chain which results in a reduction of the unit costs. The invention makes a novel heating element possible that employs the latest ceramics technology, and whose production process produces a ‘single-piece’ heating resistor where the material of the heating conductor is arranged in full surface-to-surface contact, i.e. with a good thermal transfer, on the carrier element. Due to the resulting effective and, in particular, fast and uniform thermal transfer of the generated heat from the heating conductor to the carrier element it is possible to transfer the heat via a large surface from the heating resistor to the airflow. On the one hand, this diminishes the danger of the heating conductor burning through and, on the other hand, has a favorable effect on the necessary airflow, which minimizes the mechanical stresses on the blower drive system.

For the heating conductor, ceramic materials like SiC or MoSi₂—Al₂O₃ are used that not only have excellent properties regarding corrosion resistance, wear resistance, and thermal conductivity but also, above all, have a high electrical conductivity. In order to use such ceramic materials for a heating resistor, it is necessary to adjust the electric resistance value of the known electrically conductive ceramic materials.

This can be accomplished either by reducing the electrical conductivity of the ceramic material itself or by means of selecting an appropriate geometry factor for the heating conductor. The conductivity of the ceramic can be influenced by a variation of their portions of conductive and non-conductive materials. In addition, an increase of the resistance value for the flow of electricity can be achieved by a built-in effective reduction of the cross-section of the heating conductor.

In conventional fashion, the heating resistor may have several adjoining disk-shaped carrier elements for the heating conductor, or several oblong carrier elements arranged one inside the other. The carrier elements have built-in air channels for the airflow, or they form such channels in between them, depending on their arrangement. Depending on the number of carrier elements, it may be necessary to use a more or less costly mechanical attachment technique and/or electrical connection technique, which can be especially simple if only one carrier element is used. Advantageously, the carrier element of the heating resistor is a tube made of an insulating ceramic material onto which the heating conductor is applied as a conductive ceramic layer on an inside and/or outside surface. The tube acts as carrier for the heating conductor, and the interior space of the tube acts at the same time as an air channel through which the airflow passes. The conductive ceramic layer of the heating conductor is applied to the tube over a large surface and with a low cross-sectional area. Due to its large surface and its full surface-to-surface connection with the tube, it makes a good heat transfer to the carrier element and the airflow passing by possible. By varying the layer thickness of the conductive ceramic layer, the electrical resistance value of the heating conductor for the heating resistor can be adjusted in a simple manner during the production.

In a preferred implementation of the invention, an inner and an outer conductive ceramic layer of the tube embrace a face of the carrier element at an air outlet side of the heating resistor of the hot air device, with the ceramic layers butting against each other, thereby establishing an electrical connection. This makes it possible to eliminate special contacting devices on the air outlet side on the face of the heating resistor which would produce an electrically conductive connection of the inner and the outer conductive ceramic layer. The production of the inner and the outer heating conductor as a single piece reduces the assembly costs, which has a positive effect on the cost per unit.

In one implementation of the heating element according to the invention, the conductive ceramic layers on the facing outer and inner surfaces of the at least two tubes of the heating resistor are connected with each other in an electrically conductive way by means of a contact element at the air inlet side. The contact elements are inserted into the tube-shaped air channels and electrically connect the facing electrically conductive ceramic layers to each other. They may be made from sheet metal, for example, as a stamped and bent part with spring action. In this case, the contact is produced by the spring force, which permits an especially simple assembly and produces a durable and reliable electrical connection.

In another preferred implementation of the invention, the innermost and the outermost electrically conductive ceramic layer of the carrier element have electrodes on the air inlet side for providing the heating resistor with electric power. The electrically conductive connection of the electrodes and the conductive ceramic layers of the heating conductors can be made by means of all connection techniques that are known to a person skilled in the art.

With a single tube, the heating current is able to flow from the inner electrode through the heating conductor applied as a surface structure to the inside of the tube towards the air outlet opening, and from there through the conductive ceramic layer on the face through the heating conductor applied as a surface structure to the outside of the tube back to the outer electrode. With two tubes arranged coaxially one inside the other, for example, the inner electrode is provided on the inner surface of the inner tube and the outer electrode is provided on the outer surface of the outer tube, each in electrical contact with the respective heating conductor, with the two tubes in conductive series connection with each other by means of the contact element referred to above. Accordingly, the heating current flows over the two inner and outer surfaces of the tubes of the heating resistor of the heating element.

Advantageously, the electrically conductive ceramic layers of the heating conductor of the heating resistor are composed of electrically conductive and electrically insulating substances, and the conductivity of the heating conductor is adjusted by the content of the insulating substance blended into the mixture. In this way, it is possible to use known and commercially available ceramic materials for the heating resistor and to apply them as layer to the carrier element. If the resistance value of the heating resistor cannot be adjusted by means of its geometry factor alone, this makes it possible to vary the conductivity of the ceramic material until the suitable resistance value is achieved.

Depending on the type of layer application, it may occur that the electrical resistance value cannot be achieved by the application of a single conductive ceramic layer. For this reason, an advantageous implementation of the invention provides for the conductive ceramic layer(s) to comprise at least two ceramic layers one on top of the other.

According to another preferred implementation of the invention, the conductive ceramic layer of the heating conductor of the heating resistor is applied by a single or multiple immersion of the carrier element in a ceramic material present in a liquid phase, and the ceramic layer of the heating conductor is bonded to the ceramic material of the carrier element of the heating resistor with full surface-to-surface contact by means of a sintering process.

For this purpose, the electrically conductive ceramic material for the heating conductor of the heating resistor is prepared as a liquid phase in which the carrier element made of the insulating ceramic material is immersed once or multiple times. This causes the inner surfaces, the outer surfaces, and the faces of the heating resistor associated with the air outlet opening to be coated with conductive ceramic material which is then bonded with full surface-to-surface contact to the carrier element by means of a subsequent sintering process. The thickness of the conductive ceramic layer can be influenced by the speed with which the carrier element is immersed in and pulled out of the liquid conductive ceramic material. However, the layer thickness and therefore the resistance value of the conductive ceramic layer are essentially varied via the adjustable viscosity of the ceramic material in its liquid phase; if necessary, they can be cumulated by multiple immersions during which the immersion and removal speed must be constant.

According to an advanced implementation of the invention, the thermal expansion of the carrier element and of the ceramic layers of the heating conductor of the heating resistor is approximately identical when heated. For this purpose, the ceramic materials for the carrier element and the heating conductor are selected to have an approximately identical expansion coefficient which ensures a durable adhesion within the entire operating temperature range. In addition, this counteracts the formation of cracks of the heating conductor and thereby largely prevents a change of the resistance value. When the hot air device is used correctly, this largely precludes the destruction of the heating element.

Due to its tubular structure, the heating element according to the invention is especially suitable for installation in a hot air device that is equipped with an external or internal device for generating an airflow. The housing with an air outlet opening has a cylindrical section for holding the heating element, an adjoining section with a blower, for example, and adjoining this a handle section in which a control unit for the heating element and/or the motor are arranged together with a motor for driving the blower. The hot air device may also be operated with an outside air supply; in that case, it contains an additional module with electronics, without a motor or blower. A hot air device equipped in this way is distinguished by an especially functionally reliable and heating element with a long working life.

### BRIEF DESCRIPTION OF THE DRAWINGS

Below, the invention is explained in detail by means of an implementation shown in the accompanying drawing.

FIG. 1 shows a perspective view of a heating element according to the invention;

FIG. 2 shows an axial section view of a tube of the heating resistor from FIG. 1 without electrical connections;

FIG. 3 shows a detailed enlargement of the heating conductor from FIG. 2;

FIG. 4 shows an alternative layer structure of the heating conductor according to FIG. 3;

FIG. 5 shows an axial section view of a heating element with two tubes arranged coaxially one inside the other, and with electrical contacts; and

FIG. 6 shows a perspective view of a hot air welding device cut open to show the heating element.

### DETAILED DESCRIPTION OF THE INVENTION

FIG. 1 shows an implementation of the heating element 1 according to the invention with heating resistors 3, 3′ in a view towards the air inlet side 10 for an airflow L. The two heating resistors 3, 3′ that are essentially tube-shaped are arranged, one nested inside the other, in a holding tube 2, and have carrier elements 5, 5′ that are arranged coaxially one inside the other and have heating conductors 4, 4′.

Like the holding tube 2 and the carrier elements 5, 5′, the heating conductors 4, 4′ are made completely of ceramic material; the holding tube 2 and the carrier elements 5, 5′ are made of an insulating ceramic material and the resistance layers 6, 6′ of the heating conductors 4, 4′ are made of an electrically conductive ceramic material. The resistance layers 6, 6′ have a small cross-sectional area and extend over the inner surfaces 7, 7′, the outer surfaces 8, 8′, and over the faces 9, 9′ of an air outlet side 11 of the heating resistors 3, 3′ of the heating element 1.

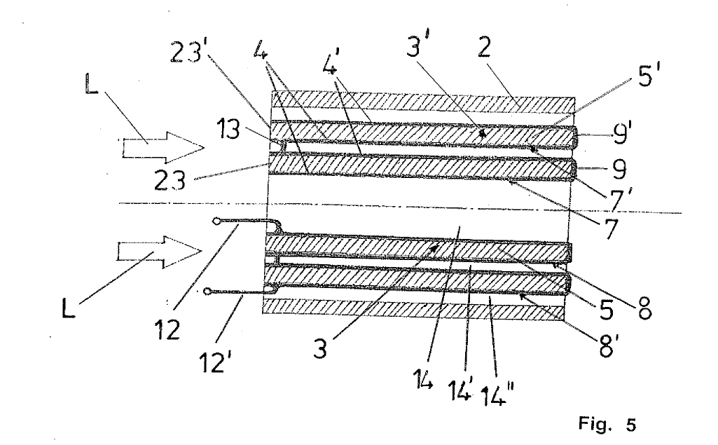

On the heating resistor 3, 3′, electrodes 12, 12′ for applying an electric voltage are mounted, as well as a contact element 13 that connects the heating resistors 3, 3′ electrically in series with each other. As can be clearly seen in FIG. 5, the electrodes 12, 12′ and the contact element 13 are located at the air inlet side 10 of the heating element 1. They permit a current to flow from the electrode 12 of the inner heating resistor 3 via the resistance layers 6, 6′ of the heating resistor 3 on the inner carrier element 5, and via the contact element 13 to the resistance layers 6, 6′ of the outer heating resistor 3′ up to its electrode 12′, and vice versa. In this process, the heating resistors 3, 3′ that are electrically connected in series with each other are heated evenly on their insides 7, 7′ and on their outsides 8, 8′.

The heating resistors 3, 3′ are arranged at a distance from each other and from the holding tube 2. They form coaxial air channels 14, 14′, 14″ that extend axially from the air inlet side 10 to the air outlet side 11 of the heating element 1. The airflow 11 flows through the heating element 1 in the direction shown while being heated at a constant rate.

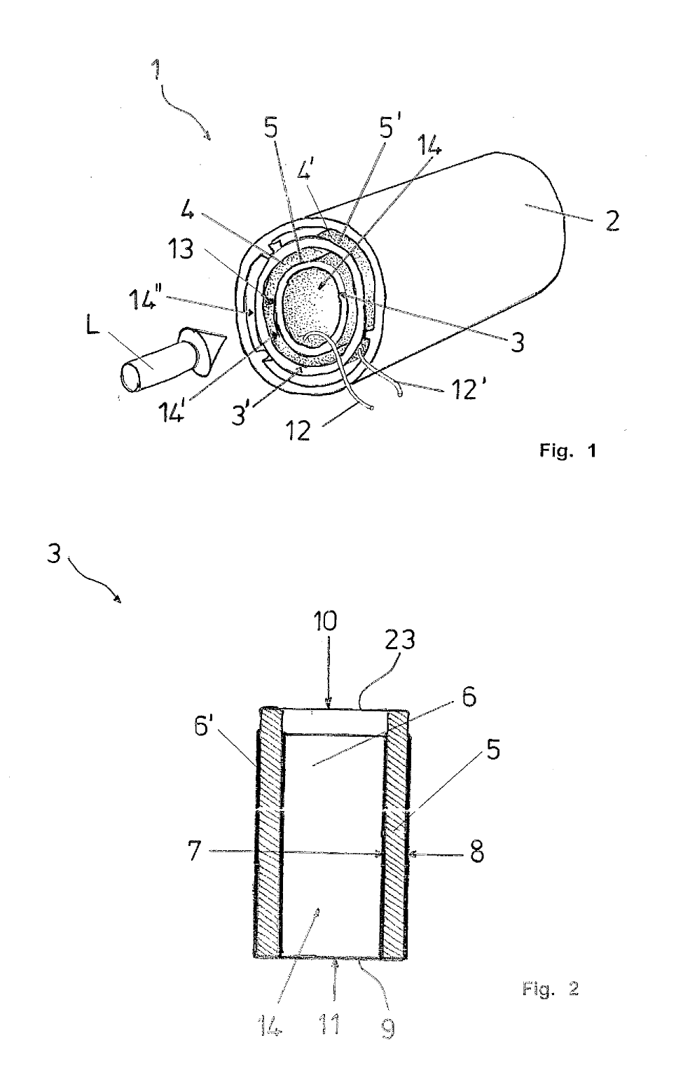

FIG. 2 shows the inner heating resistor 3 in unassembled condition. Its carrier element 5 has an inner resistance layer 6 and an outer resistance layer 6′ that embrace the face 9 of the carrier element 5 in a U-shaped configuration and are electrically connected with each other at the air outlet side 11. On the air inlet side 10, the resistance layers 6, 6′ show a small distance to the face 23 of the carrier element 5, i.e. they are reliably separated from each other electrically on the air inlet side 10 of the heating resistor 3. When the resistance layers 6, 6′ are electrically contacted, this makes a corresponding current flow in this area possible which causes the carrier element 5 to be heated evenly over its inside 7 and its outside 8.

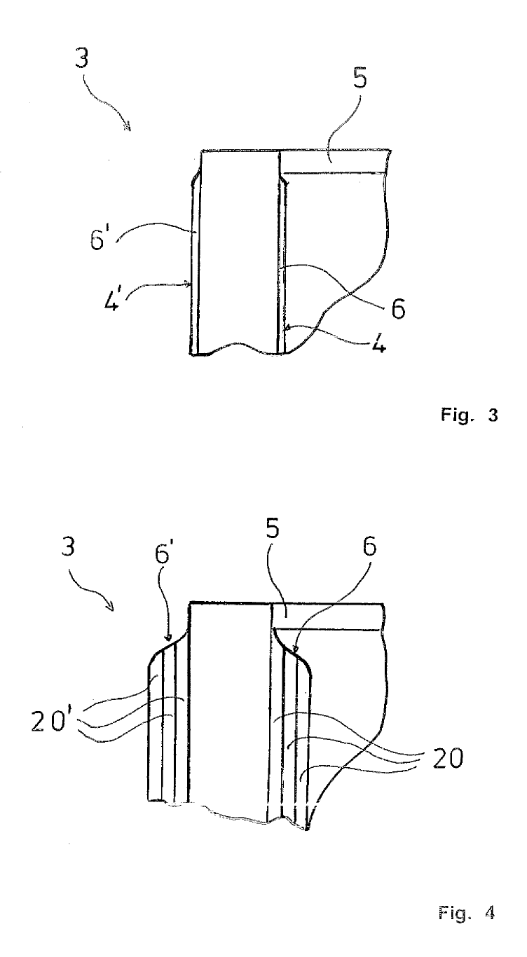

As can be seen from the enlarged view in FIG. 3, the resistance layers 6, 6′ consist of a single layer. However, if necessary, it is also possible to provide thicker resistance layers 6, 6′ that consist of three successively applied individual layers 20, 20′, as shown in FIG. 4, for example.

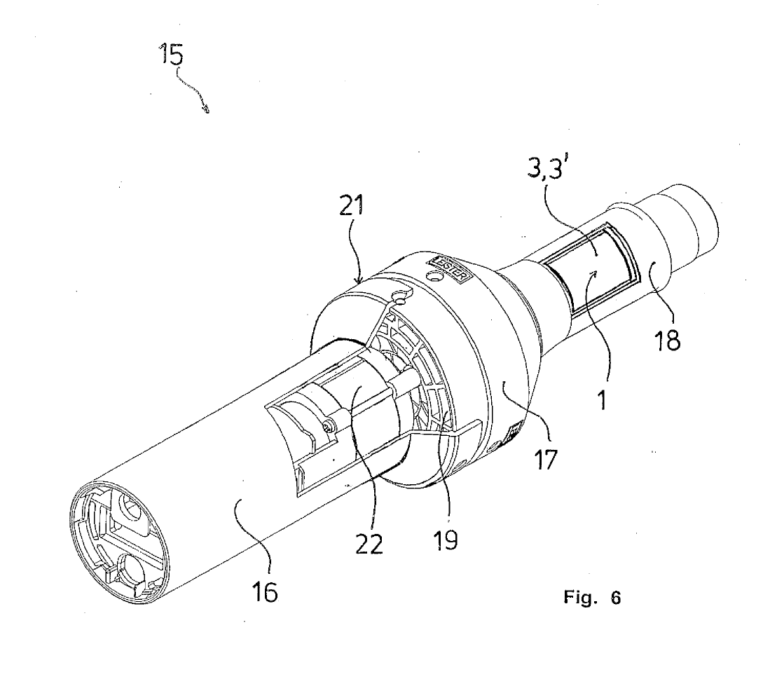

FIG. 6 shows the sample design of a hot air welding device 15 with a cylindrical handle section 16 that is followed by a blower section 17 and the cylindrical heating section 18. The heating element 1 according to the invention is located in the heating section 18, followed by the blower 19 with the drive motor 22.

1. A heating element for a hot air device with a heating resistor located in an airflow, comprising at least one air channel for the airflow and at least one heating conductor for converting electric energy to heat, and a carrier element of thermally stable material for the heating conductor where the carrier element has an electrically insulating ceramic material, and the heating conductor has an electrically conductive ceramic material, with the ceramic materials of the carrier element and of the heating conductor being in full surface-to-surface contact with each other, and where the carrier element of the heating resistor is a tube made of an insulating ceramic material onto which the heating conductor is applied as a conductive ceramic layer on an inside surface and/or on an outside surface of the tube, wherein the heating element has at least two coaxial heating resistors whose tube-shaped carrier elements are located at a distance from each other in the radial direction and delimit tube-shaped air channels that are oriented coaxially to each other.

2. A heating element according to claim 1, wherein an inner and an outer conductive ceramic layer of the tube embrace a face of the carrier element at an air outlet side of the heating resistor of the heating element, with the ceramic layers butting against each other, thereby establishing an electrical connection to each other.

3. A heating element according to claim 2, wherein the conductive ceramic layers on the facing outside and inside surfaces of the at least two tubes are connected with each other in an electrically conductive way by means of a contact element at the air inlet side.

4. A heating element according to claim 1, wherein the innermost and the outermost electrically conductive ceramic layer on the carrier element of the heating resistor has electrodes on the air inlet side for supplying the heating resistor of the heating element with electric power.

5. A heating element according to claim 1, wherein the electrically conductive ceramic layers of the heating conductor are composed of electrically conductive and electrically insulating substances, and that the conductivity of the heating conductor of the heating resistor is adjusted by the content of the insulating substance blended into the mixture.

6. A heating element according to claim 1, wherein the conductive ceramic layers of the heating conductor include a plurality of at least two ceramic layers arranged one on top of the other.

7. Heating element according to claim 1, wherein the conductive ceramic layers of the heating conductor of the heating resistor are applied by a single or multiple immersion of the carrier element in a ceramic material present in a liquid phase, and that the ceramic layers of the heating conductor are bonded to the ceramic material of the carrier element with full surface-to-surface contact by means of a sintering process.

8. A heating element according to claim 1, wherein the thermal expansions of the carrier element and of the ceramic layers of the heating conductor are approximately identical when heated.

9. A hot air device with a housing in which at least one heating element with a heating resistor is mounted, and with an internal or external air generation device wherein a heating element with a heating resistor according to claim 1.
